(19) United States
(12) Patent Application Publication
(10) Pub. No.: US 2014/0043457 A1
(43) Pub. Date: Feb. 13, 2014

(54) Pulse Wave Transit Time Using Two Cameras as Pulse Sensors

(71) Applicant: Stergios Stergiou, East Palo Alto, CA (US)

(72) Inventor: Stergios Stergiou, East Palo Alto, CA (US)

(73) Assignee: FUJITSU LIMITED, Kanagawa (JP)

(21) Appl. No.: 13/570,023

(22) Filed: Aug. 8, 2012

(51) Int. Cl. H04N 7/18

(52) U.S. Cl. 348/77; 348/E07.085

(57) ABSTRACT

A mobile device includes a first camera and a second camera to determine Pulse Wave Transit Time. A first pulse at a first location on a user's body is detected using the first camera of the mobile device. A second pulse at a second location on the user's body is detected using the second camera of the mobile device. A corresponding pair of first pulse peak and second pulse peak is extracted from the first pulse and the second pulse, respectively. A time difference between the corresponding first pulse peak and second pulse peak is computed.

### TECHNICAL FIELD

This disclosure generally relates to determining Pulse Wave Transit Time (PWTT).

### BACKGROUND

Pulse wave may be defined as the elevation of the pulse felt by the finger or shown graphically in a recording of pulse pressure, or the progressive increase of pressure radiating through the arteries that occurs with each contraction of the left ventricle of the heart, or a transient increase in blood pressure that spreads like a wave through the arterial system, which begins with the ejection of blood by the ventricles during systole. Pulse Wave Transit Time (PWTT) may be defined as the time it takes for the pulse to travel between two locations on a person's body, such as between a finger and an earlobe, between a finger and a toe, or between a finger and the forehead. PWTT is a noninvasive parameter that correlates with a person's physical conditions, such as the person's blood pressure and heart rate.

### SUMMARY

In particular embodiments, a mobile device includes a first camera and a second camera. The two cameras may be used as pulse sensors. In particular embodiments, a first pulse at a first location on a user's body is detected using the first camera of the mobile device; and a second pulse at a second location on the user's body is detected using the second camera of the mobile device. A corresponding pair of first pulse peak and second pulse peak is extracted from the first pulse and the second pulse, respectively. The time difference between the corresponding first pulse peak and second pulse peak is computed. This is the Pulse Wave Transit Time (PWTT) between the two locations on the user's body. In particular embodiments, the PWTT may be used to measure the user's physical conditions, such as the user's blood pressure or heart rate.

The object and advantages of the invention will be realized and attained at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIGS. 1A and 1B illustrate the front and the back, respectively, of an example mobile device.

FIG. 2 illustrates example method for determining Pulse Wave Transit Time (PWTT) using a mobile device.

FIG. 3 illustrates an example computing device.

### DESCRIPTION OF EXAMPLE EMBODIMENTS

On a human body, when the heart pumps blood into the aorta, it also generates a pressure wave that travels along the arteries ahead of the pumped blood. This pressure wave is called the pulse wave. Pulse Wave Transit Time (PWTT) may be defined as the time it takes for the pulse to travel between two locations on a person's body (e.g., from the aorta to a peripheral artery). It is a noninvasive parameter that correlates with some of a person's physical conditions, such as the person's blood pressure and heart rate. In particular embodiments, PWTT may be determined using a mobile device, such as a mobile telephone, that includes two cameras. The two cameras may function as two pulse sensors or pulse detectors.

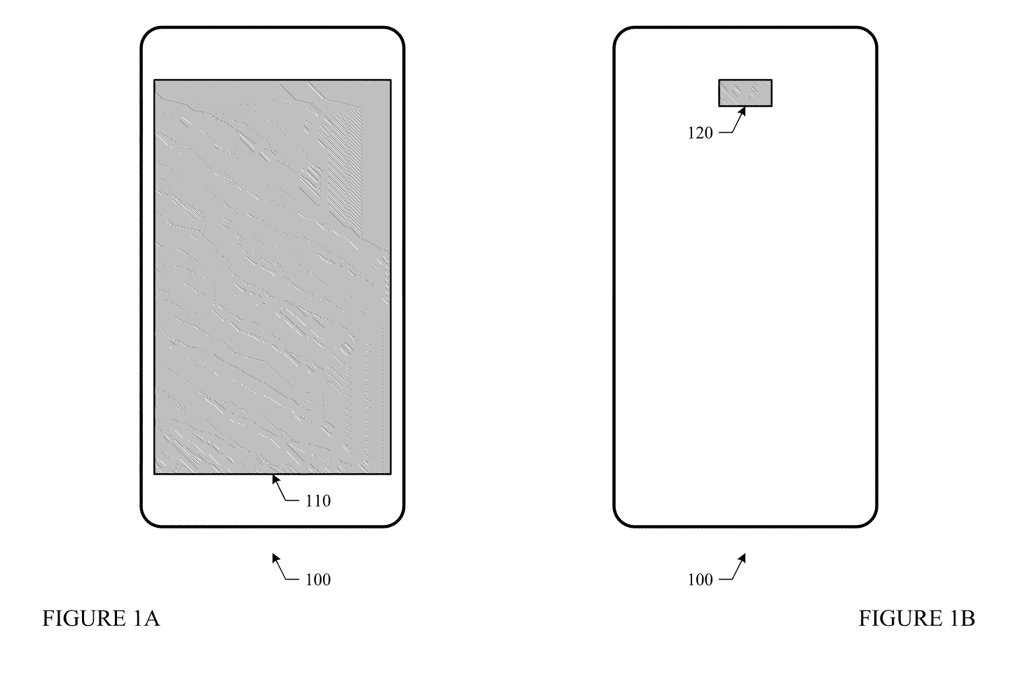

FIGS. 1A and 1B illustrate the front and back, respectively, of an example mobile device 100. In particular embodiments, on the front of mobile device 100, there may be a front-facing camera 110 incorporated in the display screen of mobile device 100. On the back of mobile device 100, there may be a second, back-facing camera 120. Many newer models of smartphones (e.g., smartphones by Apple, LG, Samsung, etc.) include both front- and back-facing cameras. In particular embodiments, the two cameras of a mobile device may be used as two pulse sensors or detectors for detecting pulse at two different locations on a user's body.

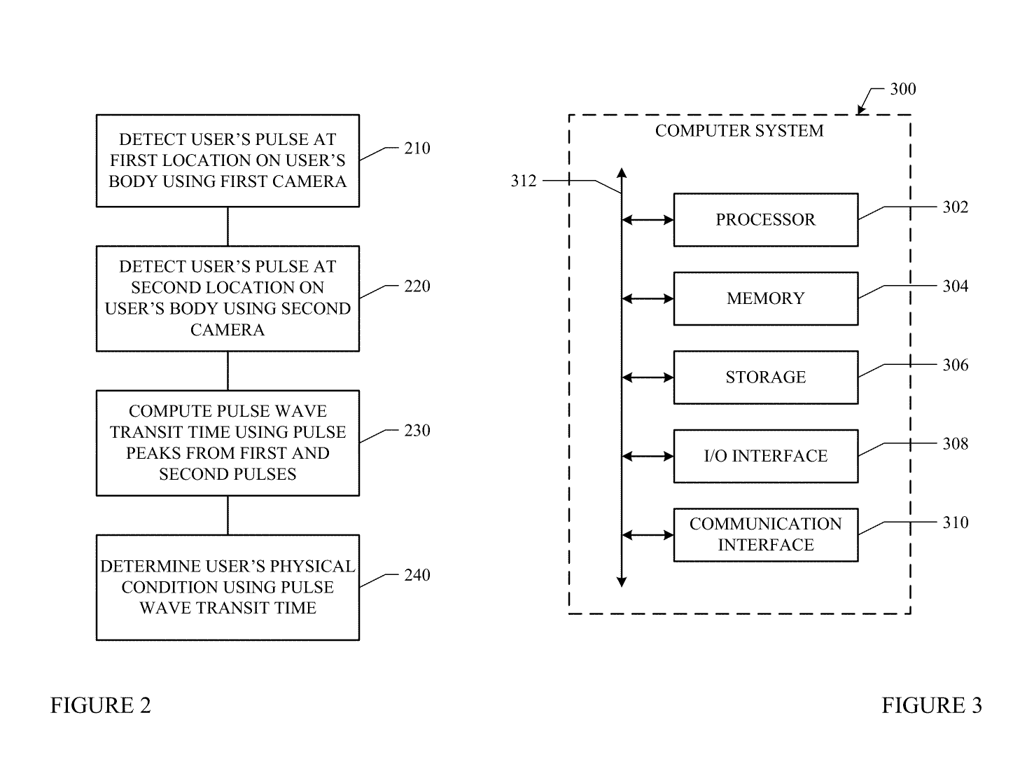

FIG. 2 illustrates example method for determining PWTT using a mobile device. In a typical scenario, for example, when a user is using his smartphone to make a telephone call, as the user holds the smartphone with his hand and brings the smartphone next to his ear, the front of the smartphone may be placed against the user's ear and the back of the smartphone may be placed against the user's fingers. In this case, the front-facing camera in the smartphone may detect the user's pulse from the user's earlobe while the back-facing camera in the smartphone may detect the user's pulse from the user's finger.

In particular embodiments, a mobile device, such as a smartphone, may include two cameras, such as a front-facing camera and a back-facing camera, and these two cameras may function as pulse sensors or detectors. At 210, the first camera of the mobile device may detect a user's pulse at a first location on the user's body. At 220, the second camera of the mobile device may detect the user's pulse at a second location on the user's body. In particular embodiments, the two cameras may continuously detect the user's pulse at two locations on the user's body at the same time.

The two locations on the user's body from where the user's pulse is detected may be any two applicable locations on a human body where a persons' pulse may be detected. For example, the two locations may be any two locations selected from earlobe, finger, wrist, forehead, neck, and toe.

In particular embodiments, a light may shine on a specific location on the user's body and the camera may track color changes in the light that passes through the user's body to detect the user's pulse. As an example, with the back-facing camera of a smartphone, its accompanying flash may shine on the user's index finger while the user's fingers are placed over the back-facing camera, and the back-facing camera may track color changes in the light that passes through the user's index finger. As another example, with the front-facing camera of the smartphone, the backlight of the screen of the mobile device (e.g., liquid crystal display (LCD) backlight) may shine on the user's ear while the front-facing camera is placed next to or against the user's ear, and the front-facing camera may track color changes in the light that passes through the user's earlobe. With some implementations, the two cameras may measure the light reflectance at the two locations on the user's body, respectively, as lights are shinning on these two locations.

The human pulse is in wave form, with periodic peaks. These peaks correspond to higher blood volumes in the arteries. In particular embodiments, at 230, a corresponding pair of peaks at the two locations on the user's body may be extracted from the pulse detected by the two cameras. The change in color or reflectance as light is shining on the user's body at the two locations, as measured by the two cameras, may indicate when the peaks occur. For example, lighter reflectance may indicate a peak.

In particular embodiments, there may be a software application executing on the mobile device that records the pulse peaks detected at the two locations on the user's body by the two cameras, respectively. With some implementations, the two cameras continuously track the changes in light color or light reflectance at the two locations on the user's body. Each time a pulse peak is detected by either camera, the software application records the time and location of the peak. Corresponding pairs of pulse peaks from the two locations may then be extracted. For example, suppose that a pulse peak is detected at the first location (e.g., earlobe) by the first camera at time t₁, and another pulse peak is detected at the second location (e.g., finger) by the second camera at time t₂, shortly after time t₁. If there is no other pulse peak detected between time t₁ and time t₂ at the second location, then these two pulse peaks may be considered a corresponding pair of pulse peaks.

In particular embodiments, the time difference between the two corresponding pulse peaks detected at the two locations, respectively, may be computed. For example, the time difference may be computed by the software application as |t₁−t₂|. This is the PWTT between the two locations on the user's body.

In particular embodiments, at 240, the PWTT may be used to determine the user's physical conditions, such as the user's blood pressure or heart rate. As an example, the speed of the pulse wave depends on the tension of the arterial walls. When the blood pressure is high, the arterial walls are tense and hard and the pulse wave travels faster. When the blood pressure is low, the arterial walls have less tension and the pulse wave travels slower. Thus, a change in blood pressure may be indicated by change in the speed of the pulse wave. In this case, the PWTT may be used to detect change in blood pressure. That is, |t₁-t₂| may be inversely related to the user's blood pressure. Similarly, a change in the user's heart rate may be indicated by change in the PWTT.

The steps illustrated in FIG. 2 may be repeated as desired. For example, the PWTT may be computed for the two locations on the user's body periodically so that the user's physical conditions may be continuously monitored.

FIG. 3 illustrates an example computing device 300, which may be a mobile device suitable for determining the PWTT. In particular embodiments, one or more computing devices 300 perform one or more steps of one or more methods described or illustrated herein. In particular embodiments, one or more computing devices 300 provide functionality described or illustrated herein. In particular embodiments, software running on one or more computing devices 300 performs one or more steps of one or more methods described or illustrated herein or provides functionality described or illustrated herein. Particular embodiments include one or more portions of one or more computing devices 300.

This disclosure contemplates any suitable number of computing devices 300. This disclosure contemplates computing device 300 taking any suitable physical form. As example and not by way of limitation, computing device 300 may be an embedded computing device, a system-on-chip (SOC), a single-board computing device (SBC) (such as, for example, a computer-on-module (COM) or system-on-module (SOM)), a desktop computing device, a laptop or notebook computing device, an interactive kiosk, a mainframe, a mesh of computing devices, a mobile telephone, a personal digital assistant (PDA), a server, or a combination of two or more of these. Where appropriate, computing device 300 may include one or more computing devices 300; be unitary or distributed; span multiple locations; span multiple machines; or reside in a cloud, which may include one or more cloud components in one or more networks. Where appropriate, one or more computing devices 300 may perform without substantial spatial or temporal limitation one or more steps of one or more methods described or illustrated herein. As an example and not by way of limitation, one or more computing devices 300 may perform in real time or in batch mode one or more steps of one or more methods described or illustrated herein. One or more computing devices 300 may perform at different times or at different locations one or more steps of one or more methods described or illustrated herein, where appropriate.

In particular embodiments, computing device 300 includes a processor 302, memory 304, storage 306, an input/output (I/O) interface 308, a communication interface 310, and a bus 312. Although this disclosure describes and illustrates a particular computing device having a particular number of particular components in a particular arrangement, this disclosure contemplates any suitable computing device having any suitable number of any suitable components in any suitable arrangement.

In particular embodiments, processor 302 includes hardware for executing instructions, such as those making up a computer program. As an example and not by way of limitation, to execute instructions, processor 302 may retrieve (or fetch) the instructions from an internal register, an internal cache, memory 304, or storage 306; decode and execute them; and then write one or more results to an internal register, an internal cache, memory 304, or storage 306. In particular embodiments, processor 302 may include one or more internal caches for data, instructions, or addresses. This disclosure contemplates processor 302 including any suitable number of any suitable internal caches, where appropriate. As an example and not by way of limitation, processor 302 may include one or more instruction caches, one or more data caches, and one or more translation lookaside buffers (TLBs). Instructions in the instruction caches may be copies of instructions in memory 304 or storage 306, and the instruction caches may speed up retrieval of those instructions by processor 302. Data in the data caches may be copies of data in memory 304 or storage 306 for instructions executing at processor 302 to operate on; the results of previous instructions executed at processor 302 for access by subsequent instructions executing at processor 302 or for writing to memory 304 or storage 306; or other suitable data. The data caches may speed up read or write operations by processor 302. The TLBs may speed up virtual-address translation for processor 302. In particular embodiments, processor 302 may include one or more internal registers for data, instructions, or addresses. This disclosure contemplates processor 302 including any suitable number of any suitable internal registers, where appropriate. Where appropriate, processor 302 may include one or more arithmetic logic units (ALUs); be a multi-core processor; or include one or more processors 302. Although this disclosure describes and illustrates a particular processor, this disclosure contemplates any suitable processor.

In particular embodiments, memory 304 includes main memory for storing instructions for processor 302 to execute or data for processor 302 to operate on. As an example and not by way of limitation, computing device 300 may load instructions from storage 306 or another source (such as, for example, another computing device 300) to memory 304. Processor 302 may then load the instructions from memory 304 to an internal register or internal cache. To execute the instructions, processor 302 may retrieve the instructions from the internal register or internal cache and decode them. During or after execution of the instructions, processor 302 may write one or more results (which may be intermediate or final results) to the internal register or internal cache. Processor 302 may then write one or more of those results to memory 304. In particular embodiments, processor 302 executes only instructions in one or more internal registers or internal caches or in memory 304 (as opposed to storage 306 or elsewhere) and operates only on data in one or more internal registers or internal caches or in memory 304 (as opposed to storage 306 or elsewhere). One or more memory buses (which may each include an address bus and a data bus) may couple processor 302 to memory 304. Bus 312 may include one or more memory buses, as described below. In particular embodiments, one or more memory management units (MMUs) reside between processor 302 and memory 304 and facilitate accesses to memory 304 requested by processor 302. In particular embodiments, memory 304 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 304 may include one or more memories 304, where appropriate. Although this disclosure describes and illustrates particular memory, this disclosure contemplates any suitable memory.

In particular embodiments, storage 306 includes mass storage for data or instructions. As an example and not by way of limitation, storage 306 may include an HDD, a floppy disk drive, flash memory, an optical disc, a magneto-optical disc, magnetic tape, or a Universal Serial Bus (USB) drive or a combination of two or more of these. Storage 306 may include removable or non-removable (or fixed) media, where appropriate. Storage 306 may be internal or external to computing device 300, where appropriate. In particular embodiments, storage 306 is non-volatile, solid-state memory. In particular embodiments, storage 306 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 306 taking any suitable physical form. Storage 306 may include one or more storage control units facilitating communication between processor 302 and storage 306, where appropriate. Where appropriate, storage 306 may include one or more storages 306. Although this disclosure describes and illustrates particular storage, this disclosure contemplates any suitable storage.

In particular embodiments, I/O interface 308 includes hardware, software, or both providing one or more interfaces for communication between computing device 300 and one or more I/O devices. Computing device 300 may include one or more of these I/O devices, where appropriate. One or more of these I/O devices may enable communication between a person and computing device 300. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 308 for them. Where appropriate, I/O interface 308 may include one or more device or software drivers enabling processor 302 to drive one or more of these I/O devices. I/O interface 308 may include one or more I/O interfaces 308, where appropriate. Although this disclosure describes and illustrates a particular I/O interface, this disclosure contemplates any suitable I/O interface.

In particular embodiments, communication interface 310 includes hardware, software, or both providing one or more interfaces for communication (such as, for example, packet-based communication) between computing device 300 and one or more other computing devices 300 or one or more networks. As an example and not by way of limitation, communication interface 310 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 310 for it. As an example and not by way of limitation, computing device 300 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computing device 300 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computing device 300 may include any suitable communication interface 310 for any of these networks, where appropriate. Communication interface 310 may include one or more communication interfaces 310, where appropriate. Although this disclosure describes and illustrates a particular communication interface, this disclosure contemplates any suitable communication interface.

In particular embodiments, bus 312 includes hardware, software, or both coupling components of computing device 300 to each other. As an example and not by way of limitation, bus 312 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 312 may include one or more buses 312, where appropriate. Although this disclosure describes and illustrates a particular bus, this disclosure contemplates any suitable bus or interconnect.

Herein, reference to a computer-readable non-transitory storage medium may include a semiconductor-based or other integrated circuit (IC) (such, as for example, a field-programmable gate array (FPGA) or an application-specific IC (ASIC)), a hard disk drive (“HDD”), a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable non-transitory storage medium or a suitable combination of these, where appropriate. This disclosure contemplates one or more computer-readable storage media implementing any suitable storage. In particular embodiments, a computer-readable storage medium implements one or more portions of processor 302 (such as, for example, one or more internal registers or caches), one or more portions of memory 304, one or more portions of storage 306, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody software. Herein, reference to software may encompass one or more applications, byte code, one or more computer programs, one or more executables, one or more instructions, logic, machine code, one or more scripts, or source code, and vice versa, where appropriate. In particular embodiments, software includes one or more application programming interfaces (APIs). This disclosure contemplates any suitable software written or otherwise expressed in any suitable programming language or combination of programming languages. In particular embodiments, software is expressed as source code or object code. In particular embodiments, software is expressed in a higher-level programming language, such as, for example, C, Perl, or a suitable extension thereof. In particular embodiments, software is expressed in a lower-level programming language, such as assembly language (or machine code). In particular embodiments, software is expressed in JAVA, C, or C++. In particular embodiments, software is expressed in Hyper Text Markup Language (HTML), Extensible Markup Language (XML), or other suitable markup language.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage medium or media, or any suitable combination of two or more of these, where appropriate. A computer-readable non-transitory storage medium or media may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the invention and the concepts contributed by the inventor to furthering the art, and are to be construed as being without limitation to such specifically recited examples and conditions. Although the embodiment(s) of the present inventions have been described in detail, it should be understood that the various changes, substitutions, and alterations could be made hereto without departing from the spirit and scope of the invention.

What is claimed is:

1. A method, performed by a mobile device, comprising:
detecting a first pulse at a first location on a user's body using a first camera of the mobile device;
detecting a second pulse at a second location on the user's body using a second camera of the mobile device;
extracting a corresponding pair of first pulse peak and second pulse peak from the first pulse and the second pulse, respectively; and
computing a time difference between the corresponding first pulse peak and second pulse peak.

2. The method of claim 1, further comprising
determining the user's blood pressure using the time difference.

3. The method of claim 1, wherein:
the first location on the user's body is the user's earlobe; and
the second location on the user's body is the user's finger.

4. The method of claim 1, wherein:
the mobile device is a smartphone having a front and a back;
the first camera is on the front of the smartphone; and
the second camera is on the back of the smartphone.

5. A mobile device comprising:
a memory comprising instructions executable by one or more processors; and
the one or more processors coupled to the memory and operable to execute the instructions, the instructions causing the one or more processors to perform:
detecting a first pulse at a first location on a user's body using a first camera of the mobile device;
detecting a second pulse at a second location on the user's body using a second camera of the mobile device;
extracting a corresponding pair of first pulse peak and second pulse peak from the first pulse and the second pulse, respectively; and
computing a time difference between the corresponding first pulse peak and second pulse peak.

6. The mobile device of claim 5, wherein the instructions further causing the one or more processors to perform
determining the user's blood pressure using the time difference.

7. The mobile device of claim 5, wherein:
the first location on the user's body is the user's earlobe; and
the second location on the user's body is the user's finger.

8. The mobile device of claim 5, wherein:
the mobile device is a smartphone having a front and a back;
the first camera is on the front of the smartphone; and
the second camera is on the back of the smartphone.

9. One or more computer-readable non-transitory storage media embodying logic that is operable when executed for:
detecting a first pulse at a first location on a user's body using a first camera of a mobile device;
detecting a second pulse at a second location on the user's body using a second camera of the mobile device;
extracting a corresponding pair of first pulse peak and second pulse peak from the first pulse and the second pulse, respectively; and
computing a time difference between the corresponding first pulse peak and second pulse peak.

10. The media of claim 9, wherein the logic is further operable when executed for determining the user's blood pressure using the time difference.

11. The media of claim 9, wherein:
the first location on the user's body is the user's earlobe; and
the second location on the user's body is the user's finger.

12. The media of claim 9, wherein:
the mobile device is a smartphone having a front and a back;
the first camera is on the front of the smartphone; and
the second camera is on the back of the smartphone.
